(19) United States
(12) Patent Application Publication
(10) Pub. No.: US 2009/0288308 A1
(43) Pub. Date: Nov. 26, 2009

(54) HAND TOOL WITH A SCALE

(76) Inventor: CHIH-CHING HSIEH, Taichung Hsien (TW)

Correspondence Address: Chien-Hui Su, P. O. Box 70-121 Taichung, Taichung City, 40899, TW

(21) Appl. No.: 12/124,176

(22) Filed: May 21, 2008

(51) Int. Cl. G01B 5/14

(52) U.S. Cl. 33/810

(57) ABSTRACT

A scale of a hand tool includes a first end formed as a head having a fixed jaw integrally extending therefrom and a movable jaw movably mounted in the head. Two opposite surfaces are respectively formed on both sides of the head and each surface has an edge adjacent to the movable jaw. A series of scale lines is formed on each of the two surfaces. Each of the scale lines forms an angle with the edge of the surface and the angle is less than 90°. A scale numeral is respectively disposed near the distal end of each of the scale lines and is perpendicular relative to each of scale lines. An indicator is disposed on the movable jaw for pointing out a corresponding scale numeral of the scale lines. A handle is formed as the second end.

### BACKGROUND OF THE INVENTION

1. Field of the Invention

The present invention relates to a hand tool with a scale, and more particularly to a hand tool with a scale that has a specific angle to be easily recognized.

2. Description of Related Art

A conventional hand tool in accordance with the prior art comprises a head and a fixed jaw integrally extending therefrom. A movable jaw is movably mounted in the head to be adjustably moved relative to the fixed jaw. A worm gear is rotatably mounted in the head and engages with the movably jaw for driving the movable jaw to adjust the distance between the fixed jaw and the movable jaw. Two opposite surfaces are respectively formed on both sides of the head. The surface has an edge adjacent to the movable jaw. A series of scale lines is formed on the surface and is adjacent to the edge. Each scale line is perpendicular to the edge of the surface. A scale numeral is notched near the distal end of each of scale lines and parallel relative to each of scale lines.

However, a user usually grips the handle of the conventional hand tool along an axis of the grasping first. The scale numeral is usually slanted when the user operates the conventional hand tool. If the user wants to recognize the scale numeral and the scale lines, the conventional hand tool should be turned an angle to fix the scale numeral and the scale line to be a right position. It is inconvenient to recognize the scale numeral and the scale line in the operating situation.

The present invention has arisen to mitigate and/or obviate the disadvantages of the conventional hand tool.

### SUMMARY OF THE INVENTION

The main objective of the present invention is to provide a hand tool with a scale that has a series of parallel scale lines having a specific angle to be easily recognize.

To achieve the objective, the hand tool with the scale in accordance with the present invention comprises a first end formed as a head having a fixed jaw integrally extending therefrom and a movable jaw movably mounted in the head to be adjustably moved relative to the fixed jaw. A worm gear is rotatably mounted in the head and engages with the moveable jaw for driving the movable jaw to adjust the distance between the fixed jaw and the movable jaw. Two opposite surfaces are respectively formed on both sides of the head and each surface has an edge adjacent to the movable jaw. A series of scale lines is formed on each of the two surfaces. Each of the scale lines forms an angle with the edge of the surface and the angle is less than 90°. A scale numeral is respectively disposed near the distal end of each of the scale lines and is perpendicular relative to each of scale lines. An indicator is disposed on the movable jaw for pointing out a corresponding scale numeral of the scale lines. A handle formed as the second end.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool with a scale in accordance with the present invention;

FIG. 2A is a plan view of the hand tool with the scale in FIG. 1;

FIG. 2B is a partially enlarged plan view of the hand tool with the scale in FIG. 2A; and

FIG. 3 and FIG. 4 are operational views of the hand tool in accordance with the present invention.

### DETAILED DESCRIPTION OF THE INVENTION

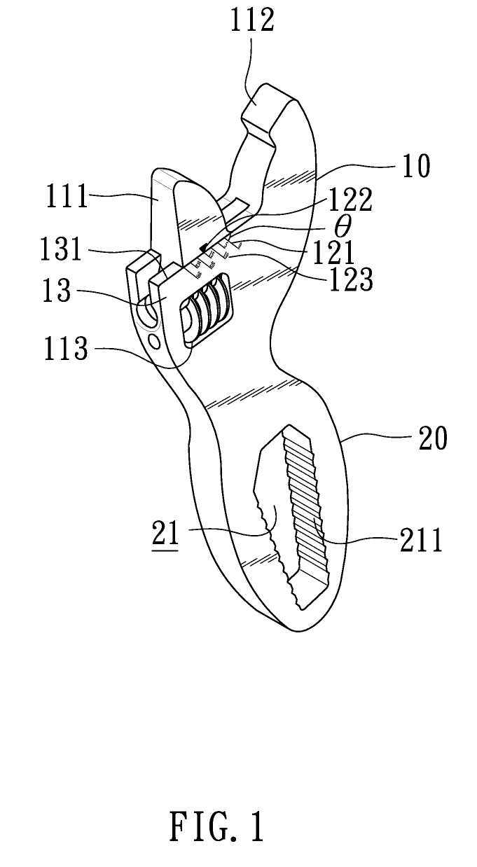

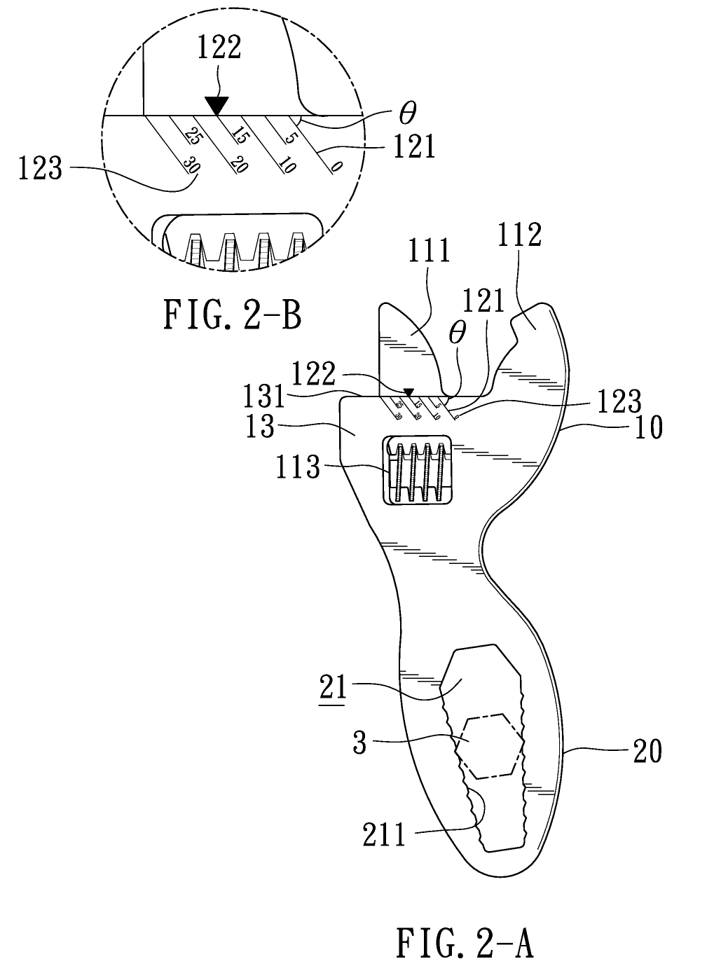

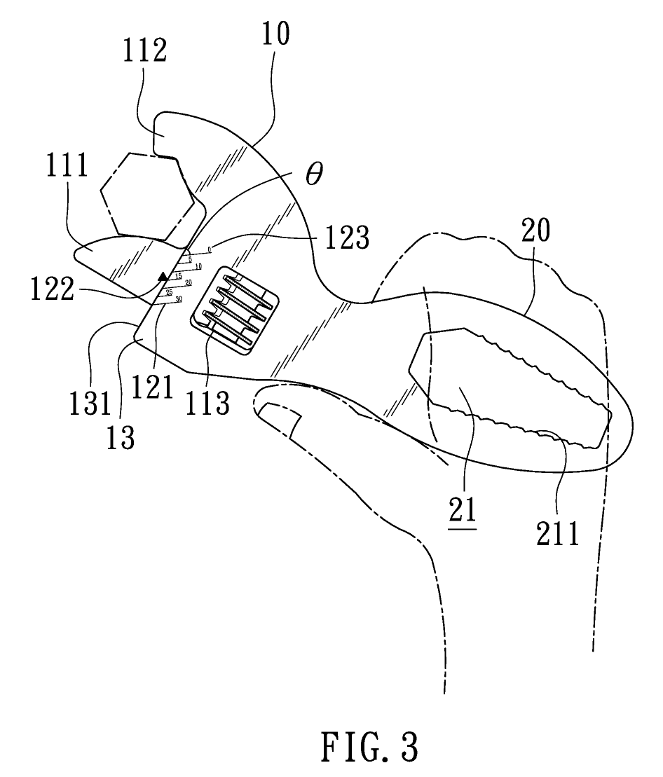

Referring to the drawings and initially to FIG. 1 and FIG. 2A, a hand tool with a scale in accordance with the present invention comprises a first end and a second end. The first end is formed as a head (10) having a fixed jaw (112) integrally extending therefrom and a movable jaw (111) movably mounted in the head (10) to be adjustably moved relative to the fixed jaw (112). A worm gear (113) is rotatably mounted in the head (10) and engages with the movable jaw (111) for driving the movable jaw (111) to adjust the distance between the fixed jaw (112) and the movable jaw (111). Two opposite surfaces (13) are respectively formed on the both side of the head (10). Each surface (13) has an edge (131) adjacent to the movable jaw (111) and the movable jaw (111) is moved along the edge (131).

The second end of the hand tool is formed as a handle (20) having a trough (21) defined therethrough. The trough (21) has two opposite sides being tapered relative to an axis of the handle (20). Each side of the trough (2 1) has a series of indentations (211) defined therein adapted for engaging with a nut (3) in auxiliary.

With reference to FIG. 2B, a series of parallel scale lines (121) is formed on the edge (131) of each of the two surfaces (13) and the series of scale lines (121) is adjacent to the edge (131). The series of scale lines (121) has two groups of lines respectively having two different lengths and the two groups of lines are alternately formed as the series of scale lines (121). Each of scale lines (121) forms an angle (θ) with the edge (131) and the angle (θ) is less than 90°. In the preferred embodiment of the present invention, the angle (θ) is 45°. A scale numeral (123) is respectively notched near the distal end of each of the scale lines (121) and perpendicular relative to each of the scale lines (121). An indicator (122) is formed on the movable jaw (111) and the scale indicator (122) is adjacent to the edge (131) for pointing out the scale numeral (123) of scale lines (121).

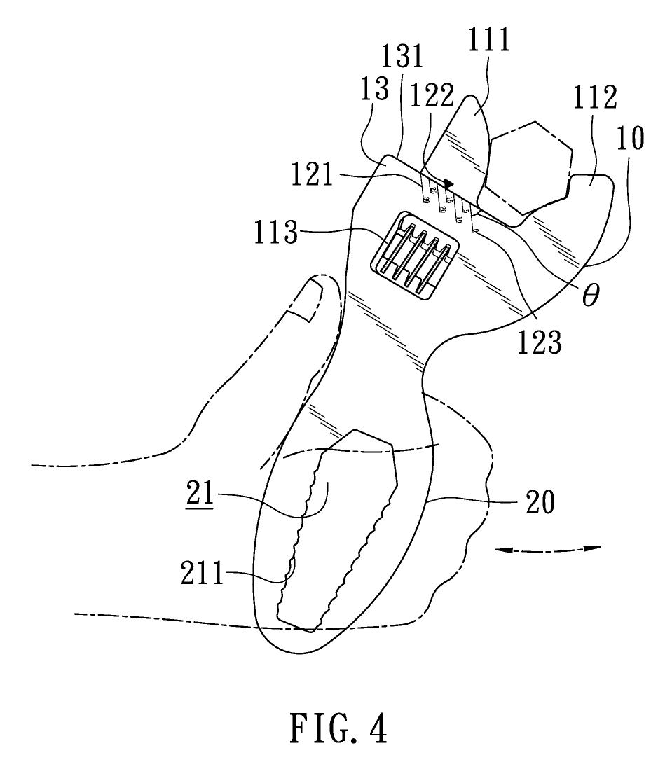

With reference to the FIG. 3 and FIG. 4, the worm gear (113) is swiveled to engage with the movable jaw (111) for adjusting the distance between the movable jaw (111) and the fixed jaw (112). The indicator (122) on the movable jaw (111) points out a corresponding one of the scale numerals (123) of scale lines (121) for showing the size of the nut (3) when the nut (3) is tightly fixed in between the fixed jaw (112) and the movable jaw (111). Each of scale lines (121) is parallel to a user and the scale numeral (123) is perpendicular to each of the series of scale lines (121) to be easily recognized by the user when the user grips the hand tool in an operating situation.

Although the invention has been explained in relation to its preferred embodiment, it is to be understood that many other possible modifications and variations can be made without departing from the spirit and scope of the invention as hereinafter claimed.

What is claimed is:

1. A scale of a hand tool comprising:
a first end formed as a head having a fixed jaw integrally extending therefrom and a movable jaw movably mounted in the head to be adjustably moved relative to the fixed jaw, a worm gear rotatably mounted in the head and engaging with the moveable jaw for driving the movable jaw to adjust the distance between the fixed jaw and the movable jaw, two opposite surfaces respectively formed on both sides of the head and each surface having an edge adjacent to the movable jaw, a series of scale lines formed on each of the two surfaces, each of the scale lines forming an angle with the edge of the surface and the angle being less than 90°, a scale numeral respectively disposed near the distal end of each of the scale lines and perpendicular relative to each of scale lines, an indicator disposed on the movable jaw for pointing out a corresponding scale numeral of the scale lines; and
a handle formed as the second end;
whereby, the scale lines and the scale numerals are easily recognized by a user when the user grips the hand tool.

2. The scale of a hand tool as claimed in claim 1, wherein the angle is 45°.

3. The scale of a hand tool as claimed in claim 1, wherein the series of scale lines has two groups of scale lines respectively having two different lengths and the two groups of lines are alternately formed with the series of scale lines.

4. The scale of a hand tool as claimed in claim 1, wherein the handle has a through defined therethrough, the through has two opposite sides and each side has a series of indentations defined therein for engaging a nut in auxiliary.

5. The scale of a hand tool as claimed in claim 4, wherein the two sides of the through are tapered relative to an axis of the handle.

6. The scale of a hand tool as claimed in claim 2, wherein the series of scale lines has two groups of scale lines respectively having two different lengths and the two groups of lines are alternately formed with the series of scale lines.

7. The scale of a hand tool as claimed in claim 2, wherein the handle has a through defined therethrough, the through has two opposite sides and each side has a series of indentations defined therein for engaging a nut in auxiliary.

8. The scale of a hand tool as claimed in claim 3, wherein the handle has a through defined therethrough, the through has two opposite sides and each side has a series of indentations defined therein for engaging a nut in auxiliary.

9. The scale of a hand tool as claimed in claim 6, wherein the handle has a through defined therethrough, the through has two opposite sides and each side has a series of indentations defined therein for engaging a nut in auxiliary.

10. The scale of a hand tool as claimed in claim 7, wherein the two sides of the through are tapered relative to an axis of the handle.

11. The scale of a hand tool as claimed in claim 8, wherein the two sides of the through are tapered relative to an axis of the handle.

12. The scale of a hand tool as claimed in claim 9, wherein the two sides of the through are tapered relative to an axis of the handle.
